(19) United States
(12) Patent Application Publication
(10) Pub. No.: US 2014/0266668 A1
(43) Pub. Date: Sep. 18, 2014

(54) Shipping container security system and method

(71) Applicants: Daniel L. Blankenship, Knoxville, TN (US); Thomas L. Mann, Knoxville, TN (US); Steven P. Kurant, Knoxville, TN (US)

(72) Inventors: Daniel L. Blankenship, Knoxville, TN (US); Thomas L. Mann, Knoxville, TN (US); Steven P. Kurant, Knoxville, TN (US)

(21) Appl. No.: 13/815,607

(22) Filed: Mar. 12, 2013

(51) Int. Cl. G08B 21/18; G08B 25/00

(52) U.S. Cl. CPC G08B 21/18; G08B 25/008
USPC 340/501; 340/541

(57) ABSTRACT

A security system for shipping containers includes: a system monitor and a device mounted on the container for locking and/or tracking. The device includes a means of measuring at least one condition of said container (e.g., time of day, ambient light level, location, speed, and acceleration), a tamper sensing system that can be adjusted based on the changes in the measured condition, and a communication system for the tamper sensing system to alert the system monitor when tampering is detected. The tamper sensing system may employ a number of approaches for detecting a tampering event, including vibration, heat, load, impact, and acceleration sensing, as well as changes in location. The tamper sensing system may further disable the lock if tampering is detected.

### BACKGROUND OF THE INVENTION

1. Field of the Invention

The invention pertains to apparatus and methods for ensuring the security of shipping containers, and more particularly to security systems having tamper detection features.

2. Description of Related Art

Much of the worldwide commerce in finished goods involves transportation in various kinds of shipping containers, such as those carried on ships, trains, and over-the-road trucks. There is a great need to protect the contents of shipping containers from theft or damage during transit, and many solutions have been proposed to address container security. These solutions may be broadly classified as locking solutions and visibility solutions. Locking solutions involve various ways to secure a container so that it can be opened only under certain conditions (e.g., a person presents a valid pass code; the container has arrived at a designated destination; etc.) Visibility solutions involve various ways to track a container, often in real time, so that users may be alerted if the container has left a prescribed area, deviated from a prescribed route, experienced a delay in scheduled progress, etc. Some solutions involve a combination of both visibility and locking functions.

Shipping containers are often in remote areas and may be unattended for periods of time, so the security devices often include various means of tamper detection. Such means may include load cells, accelerometers, tilt sensors, thermal sensors, etc., along with a communication means by which the security device can alert a central system monitor that tampering may be occurring.

Tamper detection systems are subject to the same fundamental trade-off as any other security system, viz., the need to minimize false positives while avoiding false negatives. If the sensitivity is set too high, false alarms will be generated, whereas if sensitivity is set too low, a tampering event may go undetected.

### Objects and Advantages

Objects of the present invention include the following: providing a container security system that can detect tampering; providing a container security system in which one or more tamper sensing mechanisms have variable threshold(s); providing a container security system with improved ability to minimize false positives while avoiding false negatives; providing a container security system with user-adjustable tamper detection settings; providing a container security system with automatically adjustable tamper detection settings; providing a tamper-resistant container security system having reduced power consumption. These and other objects and advantages of the invention will become apparent from consideration of the following specification, read in conjunction with the drawings.

### SUMMARY OF THE INVENTION

According to one aspect of the invention, a security system for shipping containers comprises:

a system monitor; and,

a device mounted on the shipping container comprising:
a measurement circuit to measure at least one condition of the container selected from the group consisting of: time, light level, location, speed, and acceleration;
a tamper sensing system including at least one parameter that is adjusted based on the changes in the measured condition; and,
a communication system whereby the tamper sensing system alerts the system monitor when tampering is detected.

According to another aspect of the invention a security system for shipping containers comprises:

a system monitor; and,

a device mounted on the shipping container comprising:
a locking mechanism to prevent the container from being opened without authorization;
a measurement circuit to measure at least one condition of the container selected from the group consisting of: time, light level, location, speed, and acceleration;
a tamper sensing system including at least one parameter that is adjusted based on the changes in the measured condition; and,
a communication system whereby the tamper sensing system alerts the system monitor when tampering is detected.

According to another aspect of the invention, a method for monitoring the status of a shipping container comprises:

providing a system monitor;

mounting a device on a shipping container, the device including:
a measurement circuit to measure at least one condition of the container, selected from the group consisting of: time, light level, location, speed, and acceleration;
a tamper sensing system including at least one parameter that is adjusted based on changes in the measured condition;

measuring at least one condition of said container;

adjusting at least one parameter of the tamper sensing system; and,

notifying the system monitor if tampering is detected.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 is a schematic diagram of one example of the present invention, in which a tamper sensing system is adjusted based on input from a measuring circuit, and a wireless communications system allows the tamper sensing circuit to communicate with a remote system monitor.

FIG. 2 is a schematic diagram of another example of the invention, in which a heightened security mode is achieved by adjusting the sensitivity of a vibration sensor using input on speed or location via GPS data.

FIG. 3 is a schematic flow diagram of an example of the present invention, illustrating the configuration of a “heightened security mode” based on speed of the container, and adjusting the thresholds of at least one tamper sensing accelerometer.

FIG. 4 is a schematic flow diagram of another example of the present invention, illustrating the configuration of “heightened security mode” based on speed of the container, its location within a Geofence, and its location along a predetermined route, and adjusting the thresholds of at least one tamper sensing accelerometer.

### DETAILED DESCRIPTION OF THE INVENTION

The invention comprises a tamper-detection device and method, which may be part of a larger locking and/or visibility solution for shipping containers. As used herein, the term shipping containers includes standard multimodal containers, custom containers, semi-trailers, trucks, rail cars, and virtually any enclosed, lockable space for containing items to be shipped from place to place. The device will in most cases be able to operate with some degree of autonomy and will in general have an on-board power supply (typically batteries).

The general concept may be illustrated with reference to Applicants' patented locking/visibility solutions described in U.S. Pat. Nos. 8,009,034 and 8,058,985 to Dobson et al., the entire disclosures of which are incorporated herein by reference. In this example, the device is packaged into a robust housing 2 with locking members that engage the locking bars on a shipping container to prevent the container from being opened. The device typically contains a GPS receiver or other means to monitor its position and speed 4, along with a means of communication 3 with a central system monitor 1.

The device further includes a sensor interface to allow the detection of selected events or environmental factors (including but not limited to: tilting, vibration, and tamper switches, air pressure, temperature and humidity sensors, and detectors for hazardous conditions such as the presence of chemical, biological, radiological, nuclear, and explosive agents).

It will be appreciated that the detection of tampering is as complex as the variety of methods that are available to an adversary seeking to attack or disable the device, as illustrated in the following examples.

### Example

If the device has secured the container by straddling the locking bars, one method of tampering could involve simply cutting the locking bars with a saw, torch, etc. This type of attack may be detected in several ways. First, the tension in the lock can be measured and if the tension suddenly relaxes, it indicates that the bars have been cut or deformed in some way. Second, vibration or acoustic sensors could detect signals characteristic of sawing or cutting. Third, thermal sensors could detect a temperature rise indicating a torch is being used to cut the bars. In each of these cases, the device would use its on-board communication system to alert the system monitor that tampering is occurring.

### Example

If the container is parked an adversary may hitch it to a tractor and attempt to leave the area. In this situation, movement may be sensed by vibration or acceleration. Alternatively, a change in position relative to a storage area or other approved Geofence may be detected via GPS or other input.

### Example

If an adversary attempts to attack the locking device itself, the physical effects of impact, sawing, burning, etc., may be detected by the previously mentioned vibration, thermal, acceleration, or load sensors.

### Example

An adversary may attempt to gain access to the locking device itself by means of entering a valid unlock code (e.g., as someone with inside information regarding the configuration of unlock codes). The sensing system may detect key presses on the unlock code entry means that are determined to be valid codes, but have been rendered invalid for a period of time based on automatic or manual configuration of the locking devices sensors such as GPS location, time of day, etc.

A key aspect of the present invention is based on Applicants' realization that the performance of the tamper detection system 5 can be greatly improved by incorporating an understanding of how such tampering is likely to be attempted and, more importantly, when tampering is likely or unlikely. As a simple example, physical tampering is extremely unlikely to occur when the container is moving at high speed. At the same time, while the container is moving there will be incidental movements and vibrations that might be comparable in magnitude to what might be a tampering event if the container were initially motionless. Thus, a tamper system using accelerometers with a fixed alarm threshold runs the risk of being too sensitive during transit (false positives) or not sensitive enough when parked (false negatives).

### Example

When a container is moving, vibration signatures from sensing devices such as accelerometers can be quite high depending on road conditions, load in the container, wind, etc. On the other hand when a container is parked, and thus much more vulnerable to intrusion, vibration signatures are typically much lower. Algorithms designed to automatically adjust the vibration thresholds based on the speed of the container would minimize false positive and false negative alarms. One condition that will preferably be accounted for is when the container is stopped in traffic due to traffic congestion. The adjustment of vibration thresholds could depend on the amount of time the container has been stopped. The adjustment of the vibration thresholds could also be made based on the GPS location of the container and whether or not it is within a prescribed route. The adjustment of vibration thresholds could also be made based on the time of day. Any combination the above information from sensors including current and historical data can be used to adjust vibration thresholds.

It will be appreciated that, as with many systems involving security and situational awareness, it is often useful to employ several inputs as a further means of distinguishing benign conditions from hostile ones.

### Example

As noted above, tampering is much more likely to occur when the container is stopped than when it is moving. Similarly, tampering is much more likely to occur when a container is parked than when it is briefly stopped in traffic. Using a combination of GPS and accelerometers, the system may detect that the container has stopped moving along its route, but is still vibrating in a way that suggest that the truck is idling in traffic. In this case, the tamper threshold would not normally be adjusted from the lower or “moving” setting to the higher or “parked” setting.

### Example

Tampering is also much more likely to occur when the container is stopped and it is night time. Using a combination of accelerometers, GPS, and time of day, or light sensors, the tamper threshold could be adjusted to a lower setting during the “heightened security mode” of parked and night time. The GPS latitude along with date and time of day can determine the time of sun set and sun rise for any given location.

### Example

Another time that tampering is much more likely is when a driver stops temporarily for food, gas, or rest. During these times a “heightened security code” could be manually entered into the locking device to cause the device to adjust the sensor thresholds to a lower level. The heightened security mode could be configured to last for a specific period of time or until a code is entered to cancel the “heightened security mode”.

### Example

Another time tampering is much more likely is when a container is being stored at an intermediate site awaiting pickup. Using a combination of GPS location, speed, date, and time of day, a “heightened security mode” could be configured for a specific period of time within a specific geographic location (Geofence). While the container is within the Geofence and during the date and time period configured, the thresholds of sensors could be adjusted to be more sensitive.

### Example

Tampering is much more likely when a container is not at its source and destination locations. A combination of GPS location, speed, vibration, and key presses on a keypad for unlock code entry could be used to adjust the thresholds of sensors. For example if the container is not at its source or destination location, stopped at a truck stop, but idling, and a key is pressed the sensors could configure a “heightened security mode”. This mode could send a warning communication transmission and also adjust the vibration sensors to be just above the idling vibration signature.

### Example

Tampering is much more likely when a container is within a short distance of its source or destination location such as within 200 miles or less. A combination of GPS location and speed could be used to communicate an alert to an operator that the container is in a vulnerable situation and should be monitored carefully. If the locking device computes its location, based on GPS location, to be within a pre-configured distance from a pre-determined location and its speed falls below a pre-configured threshold, a “heightened security mode” could be entered and adjustments made to the sensors to adjust their thresholds and or reporting intervals. The communication intervals could also be adjusted to information to operators more frequently.

An additional benefit to making adjustments to sensor threshold settings based on measured conditions of the container is to conserve battery power. By using measured parameters to determine times when a container is more likely to be tampered with, sensor monitoring times and communication times can be adjusted to reduce the overall amount of battery power the system uses and thus extend battery life.

A further benefit to making adjustments to sensor threshold settings based on measured conditions of the container is to reduce the amount of communication data. By using measured parameters to adjust sensor thresholds and alarm reporting frequency, there can be a cost savings benefit since communications costs are measured in number of bytes of data.

Applicants contemplate that in many instances the tamper sensing system 5 will be part of a larger visibility and locking solution. In such cases, the tamper circuit may be configured not only to alert the remote system monitor or central station, but also to disable the lock 6 from being unlocked. Thus, e.g., if the container is stopped or parked, and tampering is detected, a person will be unable to unlock the container even if a valid unlock code is known.

It will be appreciated that the inventive device 3 may communicate with the remote system monitor 1 using any suitable wireless communication protocol, such as cellular telephone, satellite telephone, radio, or other means as taught in the aforementioned U.S. Pat. Nos. 8,009,034 and 8,058,985. When a locking device 6 is used, communication between the tamper sensing system 5 and the lock may be hard wired or it may use any suitable short-range wireless communication protocol as are well known in the art.

We claim:

1. A security system for shipping containers comprising:
a system monitor; and,
a device mounted on said shipping container comprising:
a measurement circuit to measure at least one condition of said container selected from the group consisting of: time, light level, location, speed, and acceleration;
a tamper sensing system including at least one parameter that is adjusted based on the changes in said measured condition; and,
a communication system whereby said tamper sensing system alerts said system monitor when tampering is detected.

2. The system of claim 1 wherein the sensitivity of said tamper sensing system is increased when said measurement circuit detects a condition selected from the group consisting of:
said container is stationary;
said container has been in the same location for a preset period of time;
said container is parked at a selected location relative to a selected Geofence;
said light level indicates that it is dark in the vicinity of said container;
said time is between local sunset and sunrise at said container's present location;
the location of said container deviates from a preplanned route; and,
said time indicates that said container is overdue at a preplanned destination.

3. The system of claim 1 wherein the sensitivity of said tamper sensing system may be manually increased or decreased after entry of an approved authorization code.

4. The system of claim 1 wherein said tamper sensing system comprises a device selected from the group consisting of: vibration sensors, tilt switches, accelerometers, temperature sensors, acoustic sensors, and tension sensors.

5. The system of claim 1 further comprising a locking device to prevent said container from being opened without authorization.

6. The system of claim 5 wherein said tamper sensing system can disable said locking device from being unlocked if tampering is detected.

7. A security system for shipping containers comprising:
a system monitor; and,
a device mounted on said shipping container comprising:
a locking mechanism to prevent said container from being opened without authorization;
a measurement circuit to measure at least one condition of said container selected from the group consisting of: time, light level, location, speed, and acceleration;
a tamper sensing system including at least one parameter that is adjusted based on the changes in said measured condition; and,
a communication system whereby said tamper sensing system alerts said system monitor when tampering is detected.

8. The system of claim 7 wherein said tamper sensing system can disable said locking device from being unlocked if tampering is detected.

9. The system of claim 7 wherein the sensitivity of said tamper sensing system is increased when said measurement circuit detects a condition selected from the group consisting of:
said container is stationary;
said container has been in the same location for a preset period of time;
said container is parked at a selected location relative to a selected Geofence;
said light level indicates that it is dark in the vicinity of said container;
said time is between local sunset and sunrise at said container's present location;
the location of said container deviates from a preplanned route; and,
said time indicates that said container is overdue at a preplanned destination.

10. The system of claim 7 wherein the sensitivity of said tamper sensing system may be manually increased or decreased after entry of an approved authorization code.

11. The system of claim 7 wherein said tamper sensing system comprises a device selected from the group consisting of: vibration sensors, tilt switches, accelerometers, temperature sensors, acoustic sensors, and tension sensors.

12. A method for monitoring the status of a shipping container, comprising:
providing a system monitor;
mounting a security device on said shipping container, said device including:
a measurement circuit to measure at least one condition of said container, selected from the group consisting of: time, light level, location, speed, and acceleration; and,
a tamper sensing system including at least one parameter that is adjusted based on changes in said measured condition;
measuring said at least one condition of said container;
adjusting said at least one parameter of said tamper sensing system; and,
notifying said system monitor if tampering is detected.

13. The method of claim 12 wherein said adjusting step comprises increasing the sensitivity of said tamper sensing system when said measurement circuit detects a condition selected from the group consisting of:
said container is stationary;
said container has been in the same location for a preset period of time;
said container is parked at a selected location relative to a selected Geofence;
said light level indicates that it is dark in the vicinity of said container;
said time is between local sunset and sunrise at said container's present location;
the location of said container deviates from a preplanned route; and,
said time indicates that said container is overdue at a preplanned destination.

14. The method of claim 12 wherein the sensitivity of said tamper sensing system may be manually increased or decreased after entry of an approved authorization code.

15. The method of claim 12 wherein said tamper sensing system comprises a device selected from the group consisting of: vibration sensors, tilt switches, accelerometers, temperature sensors, acoustic sensors, and tension sensors.

16. The method of claim 12 wherein said security device includes a locking device to prevent said container from being opened without authorization.

17. The system of claim 16 wherein said tamper sensing system can disable said locking device from being unlocked if tampering is detected.
